(19) United States
(12) Patent Application Publication
(10) Pub. No.: US 2025/0030250 A1
(43) Pub. Date: Jan. 23, 2025

(54) POWER SUPPLY SYSTEM AND METHOD OF CONTROLLING SAME AND AN ELECTRIC VEHICLE HAVING SAME

(71) Applicants: Hyundai Motor Company, Seoul (KR); Kia Corporation, Seoul (KR)

(72) Inventor: Soon Cheol Hwang, Hwaseong (KR)

(21) Appl. No.: 18/521,730

(22) Filed: Nov. 28, 2023

(30) Foreign Application Priority Data
Jul. 18, 2023 (KR) 10-2023-0092996

(51) Int. Cl. H02J 7/00; H01M 10/052; H01M 10/06

(52) U.S. Cl. CPC H02J 7/0019; H01M 10/052; H01M 10/06; H02J 7/0048; H02J 2207/20; H02J 2310/48

(57) ABSTRACT

Provided is a power supply system disclosure comprising: a high-voltage battery; a low-voltage battery configured to supply power to a low-voltage electronic device; a DC-DC converter connected between the high-voltage battery and the low-voltage battery; and a controller configured to control the DC-DC converter so as to charge the low-voltage battery by using the high-voltage battery, wherein the high-voltage battery comprises: a first cell module comprising a plurality of first battery cells; a second cell module which is electrically connected to the first cell module and comprises a plurality of second battery cells; and a switching module configured to switch between a first connection state, in which the first cell module and the second cell module charge the low-voltage battery; and a second connection state in which the second cell module charges the low-voltage battery or supplies power to the low-voltage electronic device.

### CROSS-REFERENCE TO RELATED APPLICATION

The present application claims under 35 U.S.C. § 119 (a) priority to Korean Patent Application No. 10-2023-0092996, filed on Jul. 18, 2023, the entire contents of which is incorporated herein by reference in its entirety.

### BACKGROUND

### Technical Field

The present disclosure relates to a power supply system, a method of controlling the same, and an electric vehicle.

### Background

In general, an electric vehicle includes a high-voltage battery configured to supply power to a driving motor, a low-voltage battery configured to supply low-voltage power to various electronic devices, and a low-voltage DC-DC converter for converting power of the high-voltage battery into low-voltage.

While driving, a part of the power converted into the low-voltage through the DC-DC converter is supplied to the electronic device, and the other part thereof is used to charge the low-voltage battery. In addition, the power of the low-voltage battery is supplied to the electronic device while parking.

In an autonomous vehicle, since the main controller related to autonomous driving is operated at a low-voltage, accidents may occur if a problem occurs in the low-voltage power supply system.

For this reason, a redundancy low-voltage power system is required for autonomous vehicles to prevent accidents caused by a failure in power supply to major control devices.

### SUMMARY

A purpose of an exemplary embodiment of the present disclosure is to provide a redundancy low-voltage power system and an electric vehicle including the same.

An exemplary embodiment of the present disclosure is to provide a power system capable of supplying emergency power when a problem occurs in low-voltage power supply due to deterioration of the low-voltage power system and the electric vehicle thereof.

Another purpose of the present disclosure is to provide the power system and the electric vehicle thereof, in which some cells of high-voltage battery can be switched for a low-voltage.

A power supply system according to one embodiment of the present disclosure comprises a high-voltage battery, a low-voltage battery configured to supply power to a low-voltage electronic device, a DC-DC converter connected between the high-voltage battery and the low-voltage battery, and a controller configured to control the DC-DC converter to charge the low-voltage battery by using the high-voltage battery, wherein the high-voltage battery comprises: a first cell module configured to output first voltage by a plurality of first battery cells, a second cell module electrically connected to the first cell module and configured to output second voltage by a plurality of second battery cells, and a switching module configured to switch between a first connection state in which the first cell module and the second cell module charge the low-voltage battery; and a second connection state in which the second cell module charges the low-voltage battery or supplies power to the low-voltage electronic device. In the first connection state, the first cell module and the second cell module are electrically connected to each other; and in the second connection state, a minus terminal of the first cell module is connected to a ground and a plus terminal of the second cell module is connected to charge the low-voltage battery or supply power to the low-voltage electronic device to supply power thereto.

In at least one embodiment of the present disclosure, the switching module includes a first switching element configured to switch the minus terminal of the first cell module to a connection to the ground and a second switching element configured to switch the plus terminal of the second cell module to a connection to the electronic device.

In at least one embodiment of the present disclosure, the switching module switches from the first connection state to the second connection state according to a state of the low-voltage battery.

In at least one embodiment of the present disclosure, the state of the low-voltage battery includes a deterioration state.

In at least one embodiment of the present disclosure, the deterioration state is determined using a charging time and a charged SOC when the low-voltage battery is charged by the DC-DC converter.

In at least one embodiment of the present disclosure, a third switching element configured to switch an electrical connection between the DC-DC converter and the low-voltage battery is further included.

In at least one embodiment of the present disclosure, the high-voltage battery further includes a first cell monitoring unit configured to sense states of the plurality of first battery cells, a second cell monitoring unit configured to sense states of the plurality of second battery cells, and a battery management unit configured to independently perform cell balancing of the first cell module and the second cell module according to first sensing information by the first cell monitoring unit and second sensing information by the second cell monitoring unit.

In at least one embodiment of the present disclosure, the second battery cells comprise lithium battery cells and the low-voltage battery comprises a lead-acid battery.

In at least one embodiment of the present disclosure, the second battery cells include four lithium battery cells.

In at least one embodiment of the present disclosure, the DC-DC converter is connected to the plus terminal of the second cell module, and the controller controls the DC-DC converter to charge the second cell module using the first cell module.

According to an exemplary embodiment of the present disclosure, there is provided a method of controlling a power supply system including a high-voltage battery, a low-voltage battery configured to supply power to a low-voltage electronic device, a DC-DC converter connected between the high-voltage battery and the low-voltage battery, and a controller configured to control the DC-DC converter to charge the low-voltage battery by using the high-voltage battery, wherein the high-voltage battery includes, a first cell module configured to output a first voltage by a plurality of first battery cells, a second cell module electrically connected to the first cell module and configured to output a second voltage by a plurality of second battery cells, and a switching module electrically connected between the first cell module and the second cell module, and wherein the method includes switching between a first connection state in which the first cell module and the second cell module charge the low-voltage battery; and a second connection state in which the second cell module charges the low-voltage battery or supplies power to the low-voltage electronic device.

In the first connection state, the first cell module and the second cell module are electrically connected to each other; and in the second connection state, a minus terminal of the first cell module is connected to a ground and a plus terminal of the second cell module is connected to charge the low-voltage battery or supply power to the low-voltage electronic device.

In a method of controlling according to at least one embodiment of the present disclosure, the switching may include switching the minus terminal of the first cell module to a connection to the ground and switching the plus terminal of the second cell module to a connection to the electronic device.

In a method of controlling according to at least one embodiment of the present disclosure, the switching includes switching from the first connection state to the second connection state according to a state of the low-voltage battery.

In a method of controlling according to at least one embodiment of the present disclosure, the state of the low-voltage battery includes a deterioration state.

In a method of controlling according to at least one embodiment of the present disclosure, the deterioration state may be determined using a charging time and a charged SOC when the low-voltage battery is charged by the DC-DC converter.

In a method of controlling according to at least one embodiment of the present disclosure, the method further includes switching the electrical connection between the DC-DC converter and the low-voltage battery to a release state.

In a method of controlling according to at least one embodiment of the present disclosure, the high-voltage battery further includes a first cell monitoring unit configured to sense states of the plurality of first battery cells and a second cell monitoring unit configured to sense states of the plurality of second battery cells, and the method further includes performing cell balancing of the first cell module and the second cell module independently from each other according to first sensing information by the first cell monitoring unit and second sensing information by the second cell monitoring unit.

In a method of controlling according to at least one embodiment of the present disclosure, the second battery cells include lithium battery cells, and the low-voltage battery includes a lead-acid battery.

In a method of controlling according to at least one embodiment of the present disclosure, the method further includes controlling the DC-DC converter to charge the second cell module using the first cell module.

According to one embodiment of the present disclosure, there is provided an electric vehicle comprising a high-voltage battery, a low-voltage battery configured to supply power to a low-voltage electronic device, a DC-DC converter connected between the high-voltage battery and the low-voltage battery, and a controller configured to control the DC-DC converter to charge the low-voltage battery by using the high-voltage battery, wherein the high-voltage battery comprises a first cell module configured to output first voltage by a plurality of first battery cells, a second cell module electrically connected to the first cell module and configured to output second voltage by a plurality of second battery cells, and a switching module configured to switch between a first connection state in which the first cell module and the second cell module charge the low-voltage battery; and a second connection state in which the second cell module charges the low-voltage battery or supplies power to the low-voltage electronic device. In the first connection state, the first cell module and the second cell module are electrically connected to each other; and in the second connection state, a minus terminal of the first cell module is connected to a ground and a plus terminal of the second cell module is connected to charge the low-voltage battery or supply power to the low-voltage electronic device. According to an exemplary embodiment of the present disclosure, a redundancy low-voltage power system and an electric vehicle thereof may be obtained.

According to an exemplary embodiment of the present disclosure, it is possible to obtain a power system capable of supplying emergency power when a problem occurs in low-voltage power supply due to deterioration of a low-voltage battery and an electric vehicle thereof.

In addition, according to an exemplary embodiment of the present disclosure, a power system and an electric vehicle thereof, in which some cells of a high-voltage battery may be switched for a low-voltage, may be obtained.

As discussed, the method and system suitably include use of a controller or processer.

In another embodiment, vehicles are provided that comprise an apparatus as disclosed herein.

In a fully autonomous vehicle or system, the vehicle may perform all driving tasks under all conditions and little or no driving assistance is required from a human driver. In semi-autonomous vehicle, for example, the automated driving system may perform some or all parts of the driving task in some conditions, but a human driver regains control under some conditions, or in other semi-autonomous systems, the vehicle's automated system may oversee steering and accelerating and braking in some conditions, although the human driver is required to continue paying attention to the driving environment throughout the journey, while also performing the remainder of the necessary tasks.

In certain embodiments, the present systems and vehicles may be fully autonomous. In other certain embodiments, the present systems and vehicles may be semi-autonomous.

### BRIEF DESCRIPTION OF DRAWINGS

FIG. 1 illustrates a power supply system and an electric vehicle according to an exemplary embodiment of the present disclosure.

FIG. 2 is a flowchart illustrating a method of controlling according to an exemplary embodiment of the present disclosure.

### DETAILED DESCRIPTION

Since the present disclosure is modified in various ways and has various embodiments, specific embodiments will be illustrated and described in the drawings. However, this is not intended to limit the present disclosure to specific embodiments, and it should be understood that the present disclosure includes all modifications, equivalents, and replacements included on the idea and technical scope of the present disclosure.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements.

The suffixes “module” and “unit” used herein are used only for name distinction between elements and should not be construed as being physiochemically divided or separated or assumed that they can be divided or separated.

Terms including ordinals such as “first,” “second,” and the like may be used to describe various elements, but the elements are not limited by the terms. The terms are used only for the purpose of distinguishing one element from another element.

The term “and/or” is used to include any combination of a plurality of items to be included. For example, “A and/or B” includes all three cases such as “A”, “B”, and “A and B”.

When an element is “connected” or “linked” to another element, it should be understood that the element may be directly connected or connected to another element, but another element may exist in between.

The terminology used herein is for the purpose of describing particular embodiments only and is not intended to be limiting of the disclosure. Singular expressions include plural expressions, unless the context clearly indicates otherwise. In the present application, it should be understood that the term “include” or “have” indicates that a feature, a number, a step, an operation, a component, a part, or a combination thereof described in the specification is present, but does not exclude the possibility of existence or addition of one or more other features, numbers, steps, operations, components, parts, or combinations thereof in advance.

Unless otherwise defined, all terms used herein, including technical or scientific terms, have the same meaning as that generally understood by those skilled in the art. It will be understood that terms, such as those defined in commonly used dictionaries, should be interpreted as having a meaning that is consistent with their meaning in the context of the relevant art and will not be interpreted in an idealized or overly formal sense unless expressly so defined herein.

In addition, the term “unit” or “control unit” is a term widely used for naming a controller that commands a specific function, and does not mean a generic function unit. For example, each unit or control unit may include a communication device communicating with another controller or sensor, a computer-readable recording medium storing an operating system or a logic command, input/output information, and the like, in order to control a function in charge, and one or more processors performing determination, calculation, determination, and the like necessary for controlling a function in charge.

Meanwhile, the processor includes a semiconductor integrated circuit and/or electronic devices that perform at least one or more of comparison, determination, calculation, and determination in order to achieve a programmed function. For example, the processor may be a computer, a microprocessor, a CPU, an ASIC, and a circuitry (logic circuits), or a combination thereof.

In addition, the computer-readable recording medium (or simply referred to as a memory) includes all types of storage devices in which data that can be read by a computer system is stored. For example, the memory may include at least one type of a flash memory of a hard disk, of a microchip, of a card (e.g., a secure digital (SD) card or an eXtream digital (XD) card), etc., and at least a memory type of a Random Access Memory (RAM), of a Static RAM (SRAM), of a Read-Only Memory (ROM), of a Programmable ROM (PROM), of an Electrically Erasable PROM (EEPROM), of a Magnetic RAM (MRAM), of a magnetic disk, and of an optical disk.

The recording medium is electrically connected to the processor, and the processor retrieves and records data from the recording medium. The recording medium and the processor may be integrated or may be physically separated.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Hereinafter, the embodiments of the present disclosure will be described in detail with reference to the accompanying drawings.

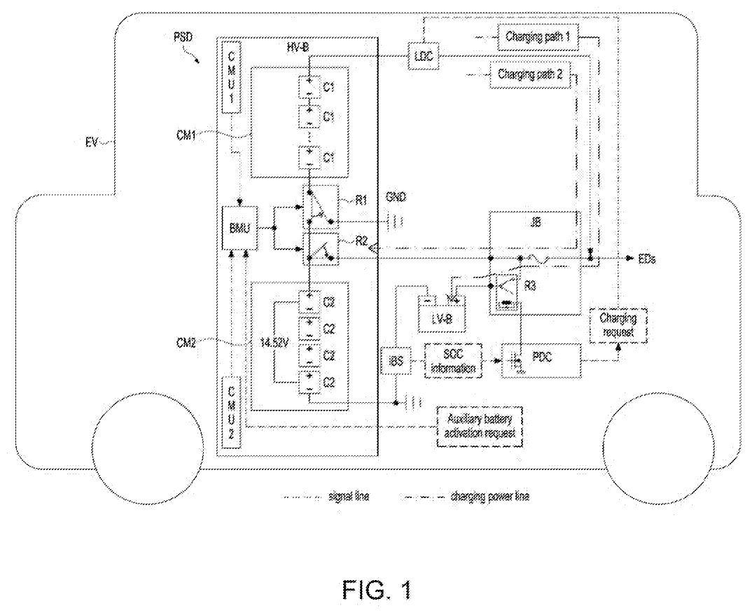

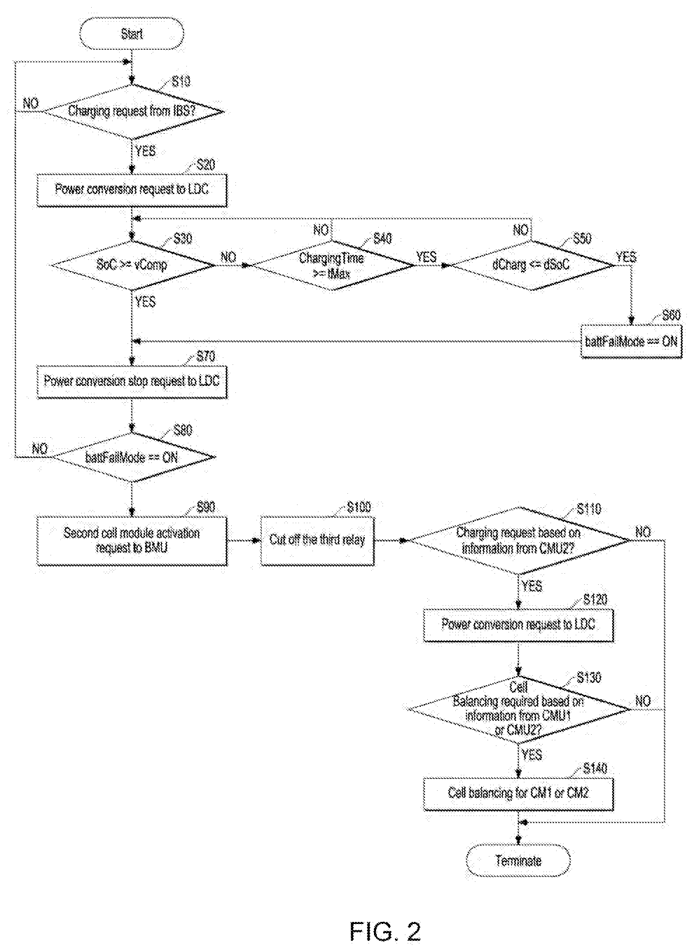

FIG. 1 illustrates a power supply system PSD and an electric vehicle EV according to an exemplary embodiment of the present disclosure, and FIG. 2 is a flowchart illustrating a method of controlling according to an exemplary embodiment of the present disclosure.

Referring to FIG. 1, the power supply system PSD included in the electric vehicle EV according to the present embodiment may include a high-voltage battery HV-B, a low-voltage battery LV-B, a low-voltage DC-DC converter LDC, a power domain controller PDC, a junction block JB, and an intelligent battery sensor IBS.

Although not shown, the electric vehicle EV may include an inverter that converts DC power of the high-voltage battery HV-B into AC power, and a driving motor that drives wheels of the vehicle EV using the AC power.

The high-voltage battery HV-B, for instance, may be fixedly installed under the floor of the passenger compartment of the vehicle and may be charged with an on-board charger (not shown).

The high-voltage battery HV-B may include a first cell module CM1 and a second cell module CM2, and each cell module includes a plurality of battery cells outputting a unit voltage within 2.7 to 4.2 V, for example.

The first cell module CM1 may output a first voltage by connecting the first battery cells C1 in series, and the second cell module CM2 may output a second voltage by connecting the second battery cells C2 in series.

In the present embodiment, the first cell module CM1 and the second cell module CM2 may be connected in series and output a required voltage, for example, approximately 400 V, approximately 800 V, or several kV.

The first cell module CM1 and the second cell module CM2 may be packaged in one battery package, but the present embodiment is not limited thereto. For example, the first cell module CM1 may be packaged in one package, and the second cell module CM2 may be separately packaged.

In the present embodiment, the first battery cell C1 and the second battery cell C2 may be lithium battery cells, but they are not limited thereto.

Further, in the present embodiment, the first battery cell C1 and the second battery cell C2 may be the same type of battery cells, but they are not limited thereto.

The number of second battery cells C2 included in the second cell module CM2 may be determined according to the voltage of the low-voltage battery LV-B.

For example, when the low-voltage battery LV-B is a battery of 12 V, the number of second battery cells C2 may be determined to correspond thereto, and when the low-voltage battery LV-B is a battery of 24 V, the number of second battery cells C2 may be determined to correspond thereto.

In the present embodiment, for example, the number of second battery cells C2 corresponding to the 12 V low-voltage battery LV-B may be 4, and accordingly, the rated voltage of the second cell module CM2 may be about 14.52V.

The high-voltage battery HV-B may include a battery management system BMS.

The battery management system BMS may include a battery management unit BMU, a cell monitoring unit CMU, and a battery junction box BJB.

The battery management system BMS may perform a cell balancing function for maintaining a constant voltage of each cell to guarantee the performance of the entire battery pack, a state of charge (SoC) function for calculating the capacity of the entire battery system, battery cooling, charging, discharging control, etc.

The battery management unit BMU may receive information of all the cells C1 and C2 from the cell monitoring unit CMU and perform a function of the battery management system BMS based on the received information.

The battery management unit BMU is illustratively composed of two micro control units, and each micro control unit has one CAN communication port. A CAN interface is included to communicate with a vehicle controller that is referred to as an superior device of the BMS, and a CAN interface is included to collect information of a cell monitoring unit CMU that is a lower device.

The cell monitoring unit CMU may be directly attached to the battery cells C1 and C2 to sense voltage, current, temperature, etc. The cell monitoring unit CMU may not perform an operation related to a battery management system BMS algorithm and may simply perform a sensing function. A plurality of battery cells may be connected to one cell monitoring unit CMU, and information of each of the plurality of battery cells are transferred to a battery management unit BMU through a CAN interface.

In the present embodiment, the cell monitoring unit CMU may include the first cell monitoring unit CMU1 and the second cell monitoring unit CMU2.

The first cell monitoring unit CMU1 may sense the first battery cells C1, and the second cell monitoring unit CMU2 may sense the second battery cells C2. The signals sensed by the first cell monitoring unit CMU1 and the second cell monitoring unit CMU2 may be transmitted to the battery management unit BMU, and the battery management unit BMU may independently perform a management function for the first battery cells C1 and a management function for the first battery cells C1 according to each sensing information.

The battery junction box BJB may be a pack-level sensing mechanism of the BMS and a connection medium between the high-voltage battery HV-B and the drive train. The battery voltage and the current flowing in and out of the battery may be measured and recorded so that the SoC can be accurately calculated. In addition, the battery junction box BJB may perform an important safety function such as a contactor, insulation monitoring, and the like, as well as overcurrent detection.

The high-voltage battery HV-B may include a switching module electrically connected between the first cell module CM1 and the second cell module CM2.

The switching module may switch between a first connection state in which the first cell module CM1 and the second cell module CM2 are connected in series, and the second connection state in which the minus terminal of the first cell module CM1 is connected to the ground and the plus terminal of the second cell module CM2 is connected to supply power to the electronic device EDs.

The switching module may include a first relay R1 as the first switching element and the second relay R2 as the second switching element.

The first relay R1 may be electrically connected to the second relay R2 from the first connection state and may be disconnected from the second relay R2 and switched to the ground connection from the second connection state.

In the first connection state, the second relay R2 may be electrically connected to the first relay R1 and disconnected from the electronic device EDs, and in the second connection state, the second relay R2 may be switched to be connected to the electronic device EDs.

The first relay R1 and the second relay R2 may be controlled by a battery management unit BMU.

The high-voltage battery HV-B may output a voltage of ‘first voltage+second voltage’ in the first connection state of the first relay R1 and the second relay R2, but the first cell module CM1 and the second cell module CM2 may be separated from each other in the second connection state. In the second connection state, the first cell module CM1 of the high-voltage battery HV-B outputs the first voltage as a high-voltage, and the second cell module CM2 outputs the second voltage as a low-voltage to the electronic device Eds.

The first relay R1 and the second relay R2 may be, for example, latch relays. Therefore, when an “on” command is received once, the “on” state is continuously maintained until the “off” command is received.

The junction block JB may connect the low-voltage battery LV-B to the electrical device EDs and also connect the DC-DC converter LDC to the low-voltage battery LV-B.

The junction block JB may include the third relay R3 as the third switching element.

The third relay R3 may be controlled by the power domain controller PDC to switch an electrical connection between the low-voltage battery LV-B and the DC-DC converter LDC.

Accordingly, when the third relay R3 electrically connects the low-voltage battery LV-B and the DC-DC converter LDC, the power of the high-voltage battery HV-B may be in a state in which it can be charged to the low-voltage battery LV-B via the DC-DC converter LDC (charging path 1).

The third relay R3 may also switch the electrical connection between the electronic device EDs and the low-voltage battery LV-B, and as will be described later, when the low-voltage battery LV-B is in a deteriorated state, it is switched to disconnect, and the electrical connection between the low-voltage battery LV-B and the electronic device EDs is disconnected.

Also, the junction block JB may electrically connect the DC-DC converter LDC to the second relay R2.

Therefore, when the switching module is switched to the second connection state, the power of the high-voltage battery HV-B may be charged to the second cell module CM2 through the DC-DC converter LDC, the junction block JB, and the second relay R2 (charging path 2).

In order to charge the low-voltage battery LV-B or the second cell module CM2, the DC/DC converter LDC is a buck DC/DC converter LDC (low-voltage DC-DC converter).

In addition, the low-voltage battery LV-B may be, for example, a battery of 12 V or 24 V, and supplies electric power to the electronic device EDs while parking.

The electronic device EDs illustratively includes devices that operate at a low-voltage in the vehicle EV such as an air conditioner, an AVN, an autonomous controller, etc.

In the present embodiment, the low-voltage battery LV-B may be a lead-acid battery, but it is not limited thereto.

The intelligent battery sensor IBS may analyze a state of the low-voltage battery LV-B and provide information such as an SoC, a battery life, and the like to the power domain controller PDC.

Hereinafter, a method of controlling the power supply system PSD of FIG. 1 will be described with reference to FIG. 2.

In S10, a charge request is transmitted from the intelligent battery sensor IBS to the power domain controller PDC according to the SoC of the low-voltage battery LV-B.

For example, when the low-voltage battery LV-B reaches the set SoC, the intelligent battery sensor IBS transmits a charge request signal to the power domain controller PDC.

In S20, when the charge request signal is transmitted, the power domain controller PDC controls the DC-DC converter LDC to convert high-voltage power into low-voltage power.

The low-voltage power converted by the DC-DC converter LDC is charged to the low-voltage battery LV-B, and the SoC of the low-voltage battery LV-B rises.

The power domain controller PDC receives the SoC information of the low-voltage battery LV-B from the intelligent battery sensor IBS and determines whether the SoC reaches a predetermined charge end SoC vComp (S30).

In S30, when it is determined that the SoC of the low-voltage battery LV-B does not reach the charge end SoC vComp, the power domain controller PDC determines the deterioration state of the low-voltage battery LV-B.

In order to determine the deterioration condition, the power domain controller PDC determines whether the charging time reaches the set time tMax from S40 and determines whether the charging quantity is equal to or less than a set deterioration SoC dSoC in S50. That is, when the set time tMax elapses but the set deterioration SoC dSoC does not reached after the charging is initiated, it means that the charging is not properly performed, and the low-voltage battery LV-B may be determined to be deteriorated.

When the charge quantity is equal to or less than the set deterioration SoC (dSoC) in S50, the power domain controller PDC determines that the low-voltage battery LV-B is in a failure state in S60 (batFailMode=ON).

If it is determined that the low-voltage battery LV-B is in the fail state, the power domain controller PDC controls the DC-DC converter LDC to stop the power conversion in S70.

Next, since the low-voltage battery LV-B is in the fail state (YES in S80), the power domain controller PDC requests the battery management unit BMU of the high-voltage battery HV-B to activate the second cell module CM2 in S90.

The battery management unit BMU switches the switching module to the second connection state according to the activation request.

That is, in order to activate the battery management unit BMU, the first relay R1 is controlled to connect the minus terminal of the first cell module CM1 to the ground, and the second relay R2 is controlled to connect the plus terminal of the second cell module CM2 to the junction block JB.

In S100, the power domain controller PDC controls the third relay R3 to switch the connection with the low-voltage battery LV-B to a release state.

Through this, the electrical connection between the DC-DC converter LDC of the low-voltage battery LV-B and the electronic device EDs is cut off, and the plus terminal of the second cell module CM2 is connected to the DC-DC converter LDC to be in a state capable of receiving charging power therefrom and is also in a state capable of supplying power to the electronic device EDs.

The second cell monitoring unit CMU2 monitors a state of the second cell module CM2 and transmits it to the battery management unit BMU. When it is determined that the second cell module CM2 needs to be charged, the battery management unit BMU transmits a charging request to the power domain controller PDC. That is, in S110, a charge request for the second cell module CM2 is transmitted to the power domain controller PDC based on the information of the second cell monitoring unit CMU2.

When the charge request is received (YES in S110), the power domain controller PDC transmits a power conversion request to the DC-DC converter LDC to charge the second cell module CM2 in S120.

In addition, the battery management unit BMU determines whether cell balancing is required for each of the first cell module CM1 and the second cell module CM2 based on sensing information of the first cell monitoring unit CMU1 and the second cell monitoring unit CMU2 (S130) and performs cell balancing independently on the first cell module CM1 and the second cell module CM2 (S140).

What is claimed is:

1. A power supply system comprising:
a high-voltage battery;
a low-voltage battery configured to supply power to a low-voltage electronic device;
a DC-DC converter connected between the high-voltage battery and the low-voltage battery; and
a controller configured to control the DC-DC converter to charge the low-voltage battery by using the high-voltage battery,
wherein the high-voltage battery comprises:
a first cell module comprising a plurality of first battery cells;
a second cell module electrically connected to the first cell module and comprising a plurality of second battery cells; and
a switching module configured to switch between a first connection state in which the first cell module and the second cell module charge the low-voltage battery; and a second connection state in which the second cell module charges the low-voltage battery or supplies power to the low-voltage electronic device.

2. The power supply system of claim 1, wherein in the first connection state, the first cell module and the second cell module are electrically connected, and in the second connection state, a minus terminal of the first cell module is connected to a ground and a plus terminal of the second cell module is connected to charge the low-voltage battery or supply power to the low-voltage electronic device.

3. The power supply system of claim 2, wherein the switching module includes a first switching element configured to switch the minus terminal of the first cell module to a connection to the ground and a second switching element configured to switch the plus terminal of the second cell module to a connection to the low-voltage electronic device.

4. The power supply system of claim 1, wherein the switching module switches from the first connection state to the second connection state according to a state of the low-voltage battery.

5. The power supply system of claim 4, wherein the state of the low-voltage battery comprises a deterioration state.

6. The power supply system of claim 5, wherein the deterioration state is determined using a charging time and a charged SOC when the low-voltage battery is charged by the DC-DC converter.

7. The power supply system of claim 3, further comprising a third switching element configured to switch an electrical connection between the DC-DC converter and the low-voltage battery.

8. The power supply system of claim 1, wherein the high-voltage battery further comprises:
a first cell monitoring unit configured to sense states of the plurality of first battery cells;
a second cell monitoring unit configured to sense states of the plurality of second battery cells; and
a battery management unit configured to perform cell balancing of the first cell module and the second cell module independently of each other according to first sensing information by the first cell monitoring unit and second sensing information by the second cell monitoring unit.

9. The power supply system of claim 1, wherein the second battery cells comprise lithium battery cells, and the low-voltage battery comprises a lead-acid battery.

10. The power supply system of claim 2, wherein the DC-DC converter is connected to the plus terminal of the second cell module, and the controller is further configured to control the DC-DC converter to charge the second cell module using the first cell module.

11. A method of controlling a power supply system comprising a high-voltage battery, a low-voltage battery configured to supply power to a low-voltage electronic device, a DC-DC converter connected between the high-voltage battery and the low-voltage battery, and a controller configured to control the DC-DC converter to charge the low-voltage battery by using the high-voltage battery, wherein the high-voltage battery comprises:
a first cell module comprising a plurality of first battery cells;
a second cell module electrically connected to the first cell module and comprising a plurality of second battery cells; and
a switching module electrically connected between the first cell module and the second cell module, and
wherein the method comprises switching between a first connection state in which the first cell module and the second cell module charge the low-voltage battery; and a second connection state in which the second cell module charges the low-voltage battery or supplies power to the low-voltage electronic device.

12. The method of claim 11, wherein in the first connection state, the first cell module and the second cell module are electrically connected, and in the second connection state, a minus terminal of the first cell module is connected to a ground and a plus terminal of the second cell module is connected to charge the low-voltage battery or supply power to the low-voltage electronic device.

13. The method of claim 11, wherein the switching comprises switching from the first connection state to the second connection state according to a state of the low-voltage battery.

14. The method of claim 13, wherein the state of the low-voltage battery comprises a deterioration state.

15. The method of claim 14, wherein the deterioration state is determined using a charging time and a charged SOC when the low-voltage battery is charged by the DC-DC converter.

16. The method of claim 13, further comprising switching the electrical connection between the DC-DC converter and the low-voltage battery to a release state.

17. The method of claim 11, wherein the high-voltage battery further comprises a first cell monitoring unit configured to sense states of the plurality of first battery cells and a second cell monitoring unit configured to sense states of the plurality of second battery cells and the method further comprises performing cell balancing of the first cell module and the second cell module independently from each other according to first sensing information by the first cell monitoring unit and second sensing information by the second cell monitoring unit.

18. The method a of claim 11, wherein the second battery cells comprise lithium battery cells, and the low-voltage battery comprises a lead-acid battery.

19. The method a of claim 11, further comprising controlling the DC-DC converter to charge the second cell module using the first cell module.

20. An electric vehicle comprising:
a high-voltage battery;
a low-voltage battery configured to supply power to a low-voltage electronic device;
a DC-DC converter connected between the high-voltage battery and the low-voltage battery; and
a controller configured to control the DC-DC converter to charge the low-voltage battery by using the high-voltage battery,
wherein the high-voltage battery comprises:
a first cell module comprising a plurality of first battery cells;
a second cell module electrically connected to the first cell module and comprising a plurality of second battery cells; and
a switching module configured to switch between a first connection state in which the first cell module and the second cell module charge the low-voltage battery; and a second connection state in which the second cell module charges the low-voltage battery or supplies power to the low-voltage electronic device.
